(19) United States
(12) Patent Application Publication
(10) Pub. No.: US 2024/0403381 A1
(43) Pub. Date: Dec. 5, 2024

(54) MULTI-OBJECTIVE MULTI-POLICY REINFORCEMENT LEARNING SYSTEM

(71) Applicant: HITACHI, Ltd., Tokyo (JP)

(72) Inventors: Takuya KANAZAWA, Santa Clara, CA (US); Haiyan WANG, Fremont, CA (US); Chetan GUPTA, San Mateo, CA (US)

(21) Appl. No.: 18/205,781

(22) Filed: Jun. 5, 2023

(51) Int. Cl. G06F 17/11

(52) U.S. Cl. CPC G06F 17/11

(57) ABSTRACT

Systems and methods described herein can involve obtaining Pareto optimal solutions through making sequential decisions in a system that has multi-dimensional rewards and a continuous state space, and is controllable through a finite discrete set of actions, involving learning a value function through reinforcement learning (RL), wherein the value function is configured to take in an input of a state and an action pair, and provides a set of vectors as output, each of the set of vectors representing an expected total sum of rewards corresponding to a sequence of future control decisions; receiving, at an initial stage of a control sequence, a request about a total sum of rewards to be achieved; and determining a sequence of actions iteratively based on the output of the value function, an observation of the current state, and the request.

### BACKGROUND

### Field

The present disclosure is generally directed to machine learning systems, and more specifically, to facilitating a multi-objective multi-policy reinforcement learning system.

### Related Art

In industrial systems, the state of the system changes dynamically and human operators must make decisions in real time, which becomes prohibitively hard when the system involves many components that nonlinearly affect each other.

Traditional supervised learning schemes in machine learning (ML) requires a large and accurate training dataset {xᵢ, yᵢ} containing the correct labels yᵢ. However, in a large dynamic system it may not be feasible to prepare comprehensive data that cover all situations that could be encountered by an ML agent. Further, it can be challenging to prepare the correct labels since it is not obvious even for human operators what is the best operation in a given state of the system.

Reinforcement Learning (RL) is a method to solve such a sequential decision-making problem in a dynamic environment. An RL agent does not need a training dataset; instead, it interacts with the environment autonomously and learns through trials and error.

In RL, the environment is formalized as a Markov Decision Process (MDP). In MDP, a trajectory (viz. an episode) of an agent is represented as a sequence of states and actions, s₀→α₀→ . . . →sₜ→αₜ→sₜ₊₁→αₜ₊₁→sₜ₊₂→αₜ₊₂→ . . . .

The actions are determined according to the policy π of the agent, such that at αₜ=π(sₜ), ∀t. The temporal dynamics of the whole system is governed by a transition kernel P(s′|s, α), which is the probability of transitioning to a new state s′ from a previous state s upon taking the action α. At each time step t the agent receives a reward rₜ∈ [symbol] from the environment.

The goal of RL is to find a policy which is best in the sense that the expectation value of the discounted cumulative rewards (called return) [symbol] _{π}[Σₜγ^{t}r^{t}] under that policy is higher than those under the other policies. Here 0<γ≤1 is a temporal discount factor.

In business, conflicting needs do occur that are difficult to satisfy simultaneously. Examples include the following: An elevator control system with multiple cars needs to minimize both the total waiting time of guests and the total electricity cost. A water reservoir (dam) needs to control the water release amount so that (i) the risk of flooding is kept below a threshold, (ii) the water supply to downstream areas is above a threshold, and (iii) the hydro-power production amount is above a threshold. A chemical plant faces the need of minimizing environmental pollution and maximizing production efficiency. In a power generator controlling problem, there is a need to balance supply and demand as much as possible, while minimizing ramping operations (rapid change of generation output) that cause damages to the generator.

In these situations, the problem to be solved is formulated as optimization in a multi-objective MDP, in which the reward has multiple components: \vec{r}ₜ∈ [symbol] ^{d}.

The return \vec{R}_{π}= [symbol] ₉₀ [Σₜγ^{t}\vec{r}ₜ] is vector-valued as well. Different policies result in different returns.

When every component of [symbol] is higher than or at least equal to the corresponding component of [symbol] , then π_{A} dominates π_{B}. If there is no policy that dominates π_{A}, it means π_{A} represents one of the “best” tradeoffs among objectives, which is “best” in the sense that it is impossible to improve all components of [symbol] simultaneously.

If π_{A} is modified such that some components of [symbol] get higher, then the other components necessarily go down.

A salient difference between single-objective MDP and multi-objective MDP is that there are in general multiple (even infinitely many) “best” policies in the latter.

The set of such policies {ππ}ₚ that are not dominated by any other policy is called the Pareto-dominant (or Pareto-optimal) policies, and the set of corresponding returns {\vec{R}_{π}|π∈{π}ₚ}⊂ [symbol] ^{d} is called the Pareto front.

The goal of multi-objective reinforcement learning (MORL) is to obtain as many Pareto-dominant policies as possible, by using an iterative algorithm. The diversity of the obtained Pareto front can be important in business applications because it provides the user with more options from which the most desirable policy may be selected.

One of the most major approaches in MORL is to map the original problem to a multitude of single-objective problems \vec{R}⇒Σᵢ₌₁^{d} wᵢ Rᵢ with Σᵢ₌₁^{d} wᵢ=1, ∀wᵢ≥0 and solve each of them via single-objective RL.

However, such related art implementations have the shortcoming that it can discover only the convex part of the Pareto front. The linear scalarization method in the related art can also be combined with stochastic dynamic programming, which requires that the state space of the system is discrete and finite.

In the related art, there is stochastic dynamic programming, which can approximately solve the Bellman optimality equation based on linear scalarization of objectives. There are several downsides to this related art approach; the state space must be discrete and finite, and, to obtain a sufficiently dense approximation of the Pareto front, such a related art method requires repeating independent optimization many times, which is computationally expensive. A full prior knowledge of transition probabilities of the environment may also be necessary. In general, however, such knowledge is quite limited in realistic use cases.

In the related art, there is also Q learning with generalized linear weights of objectives. While traditional Q-learning for MORL requires training separate value functions Q (s,α) for each different weighting of objectives, such related art methods trains a single big value function Q (s,α,w) that receives the weight vector w=(w₁, . . . , w_{d}) as additional input. Hence a single model can yield a wide range of policies by varying w without the need of retraining. It can handle continuous state spaces.

In the related art, there is also Pareto Q learning. The Bellman equation for a set of Pareto-dominant policies in multi-objective sequential optimization was derived in the related art. which unfortunately requires full prior knowledge of the transition probabilities P(s′|s, α) of the environment. The idea of Pareto Q learning implementations is to solve it approximately through an iterative algorithm, without prior knowledge of the environment. This related art method does not use any linear scalarization and can obtain a wide class of policies in a single run of training. However, this related art algorithm requires enumerating all states and hence is inapplicable to a continuous state space.

In the related art, there is multi-objective distributional RL for dispatching. This approach is formulated for a bi-objective problem and assumes that a historical record of past operations by human operators is available. In the first step, inverse reinforcement learning is used to learn the weight vector w∈ [symbol] ² that best describes the historical record. In the second step, distributional reinforcement learning is used to learn the optimal policy that maximizes the scalarized return w₁Q₁+w₂Q₂.

In the related art, there is multi-dimensional distributional deep Q learning. The problem in this related art implementation is to find the optimal policy that maximizes the scalar return (cumulative rewards) Q. Although in principle a conventional single-objective RL is sufficient to solve this problem (at least approximately), the related art implementation employs an additive decomposition of Q into several types of sub-returns so that Q=Σᵢ₌₁^{d} Qᵢ holds. Then a neural network with d outputs is trained based on a distributional Bellman equation, so as to learn the joint probability distribution function of (Q₁,Q₂, . . . , Q_{d}). In this related art implementation, a tradeoff between multiple objectives is not a focus; rather, the simultaneous modeling of multiple types of returns is performed merely as an intermediate step for solving a single-objective sequential optimization problem.

### SUMMARY

In practical business optimization problems, there are multiple Key Performance Indicators (KPIs) that are dependent with each other. Their priorities (or relative importance, or preferences) often change dynamically, implying that just sticking to a single policy is suboptimal.

Some of the related art methods require separate independent training of multiple Artificial Intelligences (AIs) each associated with a specific priority. Hence, if one wishes to get 200 different policies, the computational cost is 200 times higher than obtaining a single policy. which is prohibitively hard.

Other related art implementations allow unlimited policies by training just a single AI but requires mapping a vector-valued KPIs to a scalar KPI by way of linear weighting. It is theoretically proven that such a linear scalarization method can only access part of the set of all good (e.g., Pareto-dominant) policies, hence it runs the risk of overlooking the optimal policy that best suits the business user's demand.

Some related art implementations aim to obtain multiple policies in a single run of training without recourse to linear scalarization. However it can only handle a finite discrete state space and fails in real business use cases in which the state space is usually continuous. The technical difficulty lying here is how to model a function (mapping) from a vector to a set of vectors. A conventional neural network or other machine learning model such as decision trees and support vector machines are able to learn a mapping from a vector to a vector; compared to this, learning a map to a set is far more challenging because the size of the target set is not prefixed but can be different dependent on the input vector and can even become infinite.

To address the problems in the related art, in example implementations described herein. for a given state s and action a, the state-action value function modeled by a neural network produces a set of d-dimensional vectors Q={\vec{Q}, \vec{Q}′, \vec{Q}″, . . . }, where d is the number of objectives in the problem. The size of the set is not fixed but can be specified arbitrarily by the user for the given state and action. The neural network used in the example implementations described herein is a generative neural network which receives a single vector as input and can generate as many distinct vector outputs as desired: specifically, it samples arbitrarily many noise vectors from a user-specified probability distribution and, by using them as additional input, generates the set Q. To facilitate efficient training, the neural network adopts a trainable embedding layer of noise vectors, which maps a noise from the original space of probability distribution to another space with much higher dimension (equal to the width of the neural network. i.e., the number of neurons in the hidden layer). The parameters of this network are optimized through stochastic gradient descent minimization of a novel loss function that quantifies the set-valued temporal difference error induced by the multi-objective Bellman optimality equation, which is a generalization of the conventional scalar temporal difference error originating from the single-objective Bellman optimality equation. In short, the multi-objective Bellman optimality equation is an equality between two sets of vectors, and the loss function is designed to measure the distance (or discrepancy) between these two sets, each of which is modeled by the aforementioned generative neural network. The set-based state-action value function approach does not rest on the conventional linear scalarization method and can in principle access the entire Pareto front. After the training of the neural network is finished, multiple distinct Pareto-optimal policies (associated with different preference/prioritization over objectives) can be readily extracted from this single neural network, and it is left to the user to decide which of them to adopt for usage in a specific real-world application.

Aspects of the present disclosure can involve a method for obtaining Pareto optimal solutions through making sequential decisions in a system that has multi-dimensional rewards and a continuous state space, and is controllable through a finite discrete set of actions, the method involving learning a value function through reinforcement learning (RL), wherein the value function is configured to take in an input of a state and an action pair, and provides a set of vectors as output, each of the set of vectors representing an expected total sum of rewards corresponding to a sequence of future control decisions; receiving, at an initial stage of a control sequence, a request about a total sum of rewards to be achieved; and determining a sequence of actions iteratively based on the output of the value function, an observation of the current state, and the request.

Aspects of the present disclosure can involve a computer program for obtaining Pareto optimal solutions through making sequential decisions in a system that has multi-dimensional rewards and a continuous state space, and is controllable through a finite discrete set of actions, the computer program involving instructions involving learning a value function through reinforcement learning (RL), wherein the value function is configured to take in an input of a state and an action pair, and provides a set of vectors as output, each of the set of vectors representing an expected total sum of rewards corresponding to a sequence of future control decisions; receiving, at an initial stage of a control sequence, a request about a total sum of rewards to be achieved; and determining a sequence of actions iteratively based on the output of the value function, an observation of the current state, and the request. The computer program and instructions can be stored in a non-transitory computer readable medium and executed by one or more processors.

Aspects of the present disclosure can involve a system for obtaining Pareto optimal solutions through making sequential decisions in a system that has multi-dimensional rewards and a continuous state space, and is controllable through a finite discrete set of actions, the system involving means for learning a value function through reinforcement learning (RL), wherein the value function is configured to take in an input of a state and an action pair, and provides a set of vectors as output, each of the set of vectors representing an expected total sum of rewards corresponding to a sequence of future control decisions; means for receiving, at an initial stage of a control sequence, a request about a total sum of rewards to be achieved; and means for determining a sequence of actions iteratively based on the output of the value function, an observation of the current state, and the request.

Aspects of the present disclosure can involve an apparatus configured for obtaining Pareto optimal solutions through making sequential decisions in a system that has multi-dimensional rewards and a continuous state space, and is controllable through a finite discrete set of actions, the apparatus involving a processor, configured to learn a value function through reinforcement learning (RL), wherein the value function is configured to take in an input of a state and an action pair, and provides a set of vectors as output, each of the set of vectors representing an expected total sum of rewards corresponding to a sequence of future control decisions; receive, at an initial stage of a control sequence, a request about a total sum of rewards to be achieved; and determine a sequence of actions iteratively based on the output of the value function, an observation of the current state, and the request.

### BRIEF DESCRIPTION OF DRAWINGS

FIG. 1 is an illustration of the overall system layout, in accordance with an example implementation.

FIG. 2 is an illustration of the architecture of the Neural Network, in accordance with an example implementation.

FIG. 3 and FIG. 4 illustrates illustrate examples of the action Q value sets that appear on each side of the multi-objective Bellman equation, in accordance with an example implementation.

FIG. 5 is a flowchart showing the Flow of Model Training, in accordance with an example implementation.

FIG. 6 is a flowchart showing the Flow of Model Application, in accordance with an example implementation.

FIG. 7 illustrates an example of the sample data format in the replay buffer, in accordance with an example implementation.

FIG. 8 illustrates an example of a sample GUI display, in accordance with an example implementation.

FIG. 9 illustrates an example computing environment with an example computer device suitable for use in some example implementations.

### DETAILED DESCRIPTION

The following detailed description provides details of the figures and example implementations of the present application. Reference numerals and descriptions of redundant elements between figures are omitted for clarity. Terms used throughout the description are provided as examples and are not intended to be limiting. For example, the use of the term “automatic” may involve fully automatic or semi-automatic implementations involving user or administrator control over certain aspects of the implementation, depending on the desired implementation of one of ordinary skill in the art practicing implementations of the present application. Selection can be conducted by a user through a user interface or other input means, or can be implemented through a desired algorithm. Example implementations as described herein can be utilized either singularly or in combination and the functionality of the example implementations can be implemented through any means according to the desired implementations.

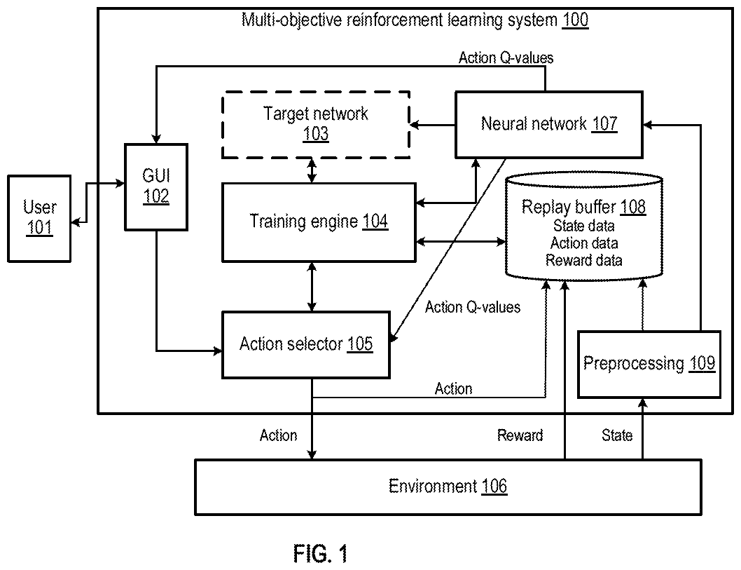

FIG. 1 is an illustration of the overall system layout 100, in accordance with an example implementation. The environment 106 is whatever system in which the RL agent is assumed to live and operate. The environment 106 could be either a digital simulator (e.g., video games, virtual car-driving simulator, virtual power plant, and so on) or a physical environment in the real world (e.g., a real car on a real road).

The “state” received from the environment 106 by preprocessing 109 and replay buffer 108 is a piece of information about the system which is used by AI to make decisions. For example, in a typical robot controller problem, the state may encode information of both the internal state of the robot (e.g., the angle of a joint, the height from the ground, the (x,y)-velocity of the body, and so on) and the state of the surrounding environment (e.g., vision sensor data, sound sensor data, wind sensor data, traffic signal data, the number and coordinates of other moving objects nearby, distance to the nearest obstacle, and so on).

The “reward” is a multi-component real-valued vector. It is assumed that the reward function has been designed and implemented on the environment by the user, and the agent is trained by using this reward as a learning signal.

The design of a reward function in each specific industrial problem is by itself a nontrivial problem, but is not the focus of the present disclosure. Accordingly, any reward function as known in the art can be used in conjunction with the example implementations described herein to facilitate the desired implementation.

The “action” executed by the agent is assumed to be selected from a finite discrete set (e.g., “turn right”, “turn left”, “go back”, and “move forward”). The overall design of the agent in FIG. 1 is basically the same as that of an orthodox RL agent using neural networks. The novelty of the example implementations described herein resides in the architecture of the neural network, the algorithm for the training engine, and the action selector as described herein. The agent is trained to learn multiple policies simultaneously and the user 101 is asked, through a human-intelligible graphical user interface (GUI) 102, to specify the desired policy to execute.

In the multi-objective reinforcement learning system 100, the user 101 interfaces with the system 100 via GUI 102. Based on the environment 106 and the inputs to the user 101, the neural network 107 is trained by the training engine 104 based on the state data, action data, and reward data in the replay buffer 108 until the target network 103 is reached. The neural network 107 provides the action Q-values to the action selector 105 and GUI 102 to generate actions for the environment 106.

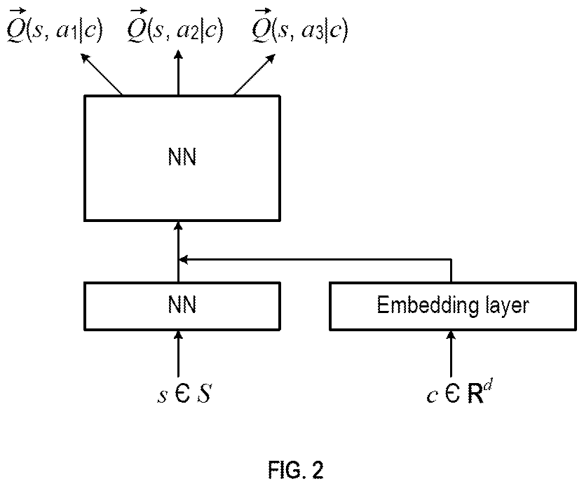

FIG. 2 is an illustration of the architecture of the Neural Network 107. in accordance with an example implementation. The architecture of the neural network 107 is shown in FIG. 2. The target network 103, represented by a square with dashed lines in the layout figure in FIG. 1, also has the same architecture. In this example implementation, the number of possible actions is assumed to be three (α∈{α₁,α₂,α₃}) but this is not a limitation and the network can be easily generalized to D actions with generic D≥2 to facilitate the desired implementation. If the number of objectives (i.e., the dimension of the reward vector) in this environment is d≥2, the output dimension of the neural network is equal to d·D, meaning that the number of neurons in the last layer of the neural network is d·D.

The main components of the neural network (represented as “NN” in the figure) can involve arbitrary combinations of standard neural network modules, including, but not limited to, multilayer perceptron, convolutional neural network, recurrent neural network, transformer, and graph neural network.

The embedding layer is a layer that performs a nonlinear transformation, mapping a dd-dimensional noise vector c (d=the number of objectives) to an N-dimensional vector, where N is the width of the main components (NN) of the neural network. The noise c is randomly sampled from a user-specified probability distribution P(c). An example is a d-dimensional normal distribution.

Another example is a uniform distribution over a unit hypercube [0,1]^{d}. Other more complex distributions, such as a mixture of Gaussian distributions, are also fine. Once P(c) is decided, it must be consistently used throughout the training and test phases of the model; it must not be changed later. There are no hard restrictions on the detailed design of the embedding layer. For example, if it is modeled via a two-layer perceptron, the output will be given by W_{2σ}(W₁c+b₁)+b₂, where W_{1,2} are weight matrices, b_{1,2} are bias vectors, and σ is an activation function such as ReLU and Tanh.

In the related art, it was empirically demonstrated that using explicit basis functions in the embedding layer helps to stabilize and accelerate training substantially. In one example implementation, assuming that P(c) is a uniform distribution over [0,1], the output of the embedding layer is given by C_{E}=σ(WC+b) where C=(1, cos πc, cos 2πc, . . . , cos(N−1)πc)∈ [symbol] ^{N}.

This allows a straightforward generalization to c∈[0,1]^{d} with d>1. Once C_{E} is obtained, it multiples the output of the bottom block (bottom “NN” block in the figure) elementwise, via the so-called dot product. This procedure enables efficient mixing of information of s and c.

For any given state s and action α∈{α₁, . . . , α_{D}}, a random noise c can be drawn from P(c) and let neural network compute the d-dimensional vector of state-action value \vec{Q}(s, α|c). This step may be repeated arbitrarily many times (e.g., I times), resulting in the set {\vec{Q}(s, α|cᵢ)}ᵢ₌₁^{I}. The set size I can be arbitrary, but in practice, it can be convenient to fix it to a large constant integer, (e.g., 1000). This set is denoted as Q(s,α). To distinguish the outputs of a trainable neural network and a target network, the output of a trainable network will be referred as Qθ(s,α), and to the output of a target network as Q_{θ}_{ₜ}(s, α), respectively.

Note the difference from the conventional deep RL. There, the state-action value function parameterized by a neural network Q (s,α) is just a single scalar; it has no capability to produce a set of vectors of arbitrary size as in the example implementations herein. This difference reflects two basic characteristics of multi-objective RL: firstly, there are multiple objectives and hence the state-action value function necessarily becomes a vector, and secondly, the desire is not in obtaining just a single “best” policy, but rather a set of Pareto-optimal policies.

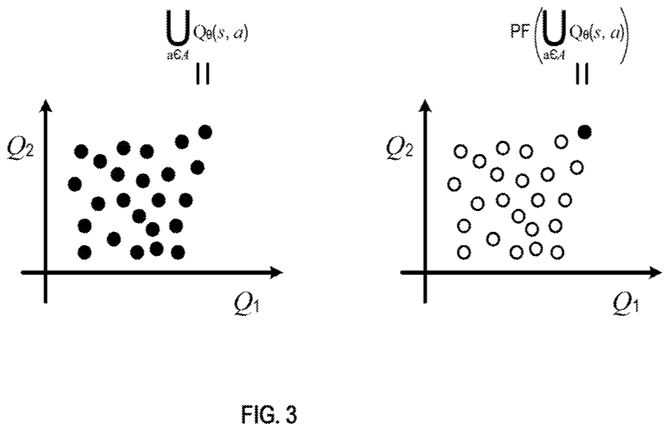

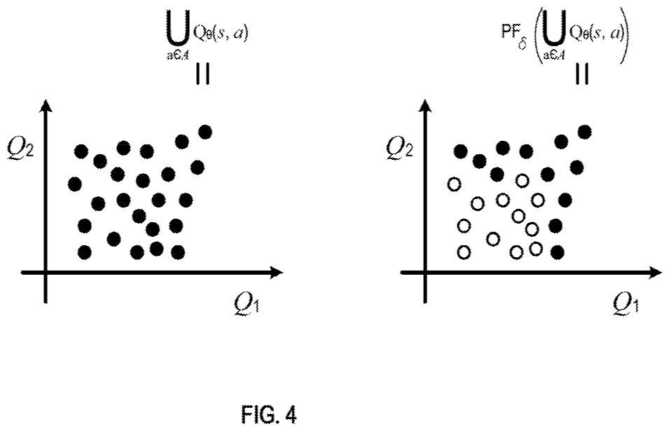

FIG. 3 and FIG. 4 illustrates examples of illustrate examples of the action Q value sets that appear on each side of the multi-objective Bellman equation, in accordance with an example implementation. In conventional deep learning for point forecast, loss functions such as the mean- squared error (y̆−y)² and the mean absolute error |y̆−y| are used to quantify the goodness of point forecast. These losses are intended to measure the difference (or distance) between two vectors.

In the example implementations described herein, a neural network is trained with a set-valued output Q_{θ}, so the loss should be able to measure the distance/dissimilarity between two sets composed of vector elements. Furthermore, the loss must be differentiable with respect to θ, in order to make gradient-based minimization of the loss possible.

There are two distance measures that fulfill these desiderata: the Maximum Mean Discrepancy (MMD) and the Sliced-Wasserstein Distance. Note that the square (or any positive power) of them also fulfill the desiderata. Collectively denote them as [symbol] (S₁, S₂). Here S₁ and S₂ are sets of d-dimensional vectors. In general, |S₁|≠|S₂|, i.e., the number of elements of S₁ and S₂ need not be equal.

In conventional deep RL, the loss is the temporal-difference error of the value function, which for a transition tuple (s,α,r,s′,d) is given by

$${( r + y ( 1 - d ) {max}_{\tilde{a}} Q ( {s}^{′} , \tilde{a} ) - Q ( s , a ) )}^{2}$$

where d∈{0,1} is a binary terminal signal; d=1 if the state s′ fulfills a terminal condition, otherwise d=0.

In example implementations described herein, this is generalized to a set-based temporal difference error, as below:

$${𝒟 ( \vec{r} ⊕ y \{ 1 - d ) P {F}_{δ} ( {U}_{\tilde{a}} {Q}_{{θ}_{t}} ( {s}^{′} , \tilde{a} ) ) , {Q}_{θ} ( s , a ) )}^{2} .$$

The symbols in this formula are defined as below.

Addition ⊕ between a vector \vec{x}and a set S is defined as \vec{x}⊕S:={\vec{x}+\vec{y}|\vec{y}∈S}. Multiplication between a scalar v and a set S is defined as vS: ={v\vec{y}|\vec{y}∈S}.

The union of sets ∪ă is taken over all actions. Note that in this union the target network Q_{θ}_{ₜ} is used (not the trainable neural network Q_{θ}!).

The novel operation PF_{δ}introduced here is a map from a set of vectors to its subset. As a special case it contains filtering the set to its rigorous Pareto front (shown FIG. 3 for a bi-objective case). If the Pareto front is strictly extracted only, then the size of the set tends to shrink drastically (from 24 to 1 in the shown example) which in turn makes the gradient-based training less efficient. To avoid this pitfall, a relaxed variation of the Pareto front is used, denoted PF₆₇, as shown in FIG. 4.

In this method, all points in the union set ∪_{ã}Q_{θ}_{ₜ}(s′,ã) are firstly ranked based on a certain metric that measures how close a point is to the Pareto front of the union set. In the second step a portion of the high-ranked points are taken as specified by δ. For example, if δ=0.25, then the top 25% of the points of the union set are selected according to the aforementioned rank.

In one example implementation, the score “1” is firstly given to all points that belong to the Pareto front. Then, all these points are removed from the union set, and the score “2” is given to all points that belong to the Pareto front of this modified union set. This procedure is repeated until all points in the set are ranked.

In another example implementation, the Pareto front of the union set is first determined. Then a score for each point is calculated as a distance to the Pareto front. As for the distance metric, we may choose any of known distances such as GD, GD+, IGD, and IGD+. Higher rank corresponds to a lower score.

The value of δ may be fixed throughout the training phase. It could also be varied dynamically, for example according to a linear-decaying schedule, where & starts with a high value (say, 0.5) and linearly decays to a small target value (say, 0.1) as a function of the elapsed training steps.

The total loss for a mini-batch B containing |B| transition tuples reads

$${ℒ}_{θ} ( B ) = \frac{1}{\vert B \vert} {\sum }_{( s , a , \vec{r} , {s}^{′} , d ) ϵ B} {𝒟 ( \vec{r} ⊕ y ( 1 - d ) {PF}_{δ} ( {U}_{\tilde{a}} {Q}_{{θ}_{t}} ( {s}^{′} , \tilde{a} ) ) , {Q}_{θ} ( s , a ) )}^{2}$$

The parameters θ of the value network are updated by taking gradient steps according to θ←θ−η∇_{θ} [symbol] _{θ}(B), where η>0 is a predetermined learning rate. Note that the gradient ∇_{θ} is taken with respect to θ, not θₜ.

The parameters of the target network slowly keep track of the trained neural network. In one example implementation, θₜ←θ is replaced every N training steps, where N is a predefined number. Namely, the target network is a periodic (delayed) copy of the trained neural network.

In another example implementation, the Polyak update θₜ←Tθₜ+(1−T)θ is performed after every training step. Here T∈[0,1] is a constant which typically assumes a value close to 1 (say. 0.995). The hyperparameters such as the mini-batch size, the learning rate, and the Polyak update rate, must be fixed by the user before starting the training phase.

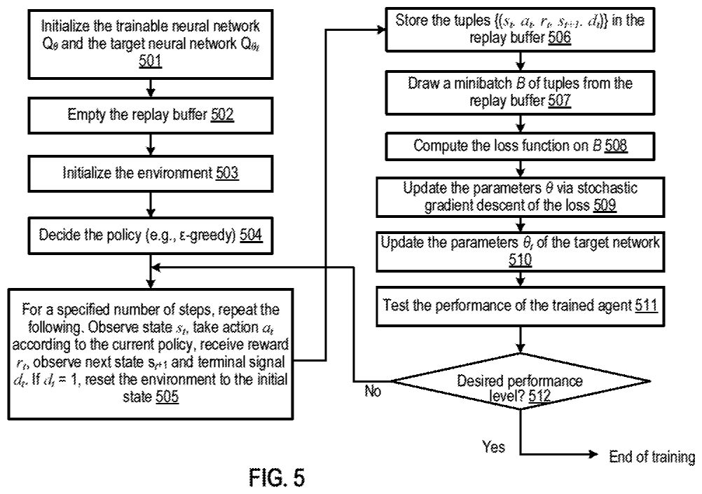

FIG. 5 is a flowchart showing the Flow of Model Training, in accordance with an example implementation. The overall flowchart of the model training phase is illustrated in FIG. 5.

At 501, the flow begins by initializing the trainable neural network Q_{θ} 107 and the target neural network Q_{θt} 103. At 502, the replay buffer 108 is emptied. At 503, the environment 106 is initalized. At 504, the flow decides the policy (e.g., ε−greedy) 504.

At 505, for a specified number of steps, the following process is iteratively repeated. The steps include observing state st, taking action at according to the current policy, receiving reward rₜ, observing next state sₜ₊₁ and terminal signal dₜ. If dₜ=1, the environment is reset to the initial state.

At 506, the flow stores the tuples {(Sₜ, aₜ, rₜ, Sₜ₊₁, dₜ)} in the replay buffer. At 507, the flow draws a minibatch B of tuples from the replay buffer. At 508, the flow computes the loss function on B. At 509, the flow updates the parameters θ via stochastic gradient descent of the loss. At 510, the flow updates the parameters θt of the target network. At 511, the flow tests the performance of the trained agent. At 512, a determination is made as to whether the desired performance level has been achieved. If so (Yes) then the training ends, otherwise (No) the flow proceeds back to 505.

At 511, the performance of the agent under training is measured, and depending on the measurement, it is decided whether more training is necessary or not at 512. This test of performance is executed by the training engine 104 of FIG. 1. In an example implementation, the training engine 104 first creates a virtual testing environment in a simulator and runs the agent for multiple episodes, computing the accumulated rewards. If the test-run scores are not substantially better than those from previous test-runs, the training is deemed converged and may be terminated. Or, the test-run scores are compared with the prefixed target score and, if the test-run scores are sufficiently close to the target score, the training shall be terminated. In general, it is not easy for the user to give a target score before the training is started, so it would be more convenient for the user to adopt the convergence criterion to automatically decide the end of training.

During the training, the Action Selector 105 illustrated in FIG. 1 selects an action, based on the value network being trained. In one example implementation, the module can draw upon a multi-objective version of the so-called ε-policy, which (i) selects an action from the set of all actions uniformly at random with probability 0<ε<1, and (ii) selects a “greedy” action with probability 1−ε. Here the concept of a “greedy” action is not a priori obvious. In single-objective RL, the goodness of an action can be uniquely assessed by how high the scalar output of the value function for this action is. In contrast, the value function in this invention yields a set of vectors. In one example implementation, the ambiguity can be resolved by (i) first computing the output of the value function for every action that can be taken in the given state. (ii) secondly, computing the union of these sets across all actions, (iii) thirdly, determining the Pareto front of that union set, (iv) fourthly. randomly choosing a point on this Pareto front, and (iv) finally, selecting an action that corresponds to the selected point.

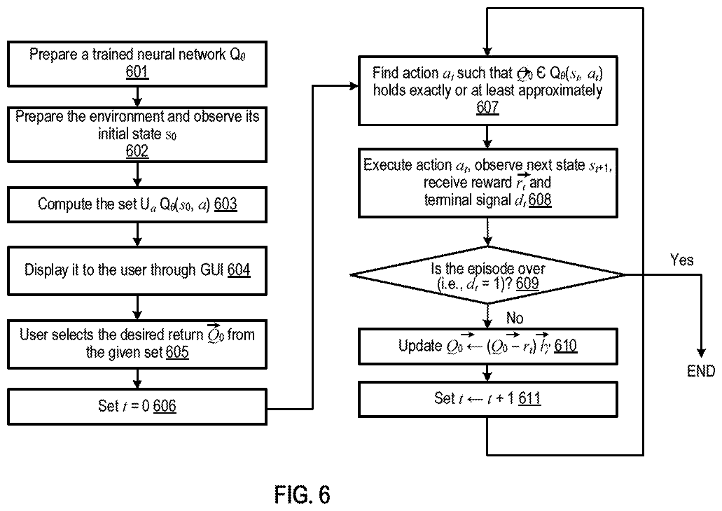

FIG. 6 is a flowchart showing the Flow of Model Application, in accordance with an example implementation. The overall flowchart of the model application phase is illustrated in FIG. 6. At 601, the neural network Qθ is trained. At 602, the flow prepares the environment and observe its initial state s₀. At 603, the flow computes the set ∪_{α}Q_{θ}(S₀, a). At 604, the flow displays it to the user through the GUI 102.

The action selection of this flowchart proceeds as follows. At 603, the flow computes the set Q_{θ}(s, α) for every action α∈A, which is straightforward because the action space A is discrete and finite. the results of which are displayed to the user at 604 through GUI 102. If \vec{Q}₀∈Q_{θ}(s, α) holds for some α∈A, then this action is taken. If there is no such α, the distance between \vec{Q}₀ and Q_{θ}(s, α), denoted Distance (\vec{Q}₀, Q_{θ}(s, α)), is computed for every α∈A and choose the action via

$$a = arg {min}_{a ∈ A} Distance ( {\vec{Q}}_{0} , {Q}_{θ} ( s , a ) ) .$$

The distance between a point x and a set S may be defined in a variety of ways. In one example implementation, the Euclidean distance is used to define such a distance as

$$Distance ( x , S ) := {min}_{y ∈ S} \vert x - y \vert .$$

The example implementations described herein can thereby handle a continuous state space in contrast to the related art implementation. This is beneficial because sensor data in industry are generally continuous and a naïve discretization method fails in high dimensions due to an exponential growth of state variables.

In related art linear-scalarization approaches to MORL, the user has to manually specify the desired weight (or preference) over competing multiple objectives. This is difficult in many cases because the user does not know the best achievable tradeoff of objectives in advance. In an example of a chemical plant, CO2 emission (in unit of kg; to be minimized) and production revenue (in unit of US dollars; to be maximized) have different units and cannot be directly compared. Moreover, a scalarization approach fails to find the concave part of the Pareto front. In the proposed method, when training of an AI agent is done, the user is presented with the set of all achievable Pareto-dominant returns (i.e., cumulative rewards) at 604 and the user only needs to select the most preferred point out of them at 605, which is more informative than just specifying an abstract linear weight with no prior input on what is the achievable tradeoffs in the long run.

At 606 to 609, an iterative flow is executed to find and execute actions. Thus, at 606. the flow is initialized so that t=0. At 607, the flow finds an action aₜ such that Q₀ [symbol] Q_{θ}(sₜ, aₜ) holds exactly or at least approximately (e.g., within a threshold). At 608, the action is executed to observe the next state and received a reward. At 609, a determination is made as to whether the iterative flow should be terminated. If so (Yes), then the flow ends, otherwise (No) the flow proceeds to 610 to update the action Q states and 611 to increment the process and proceeds back to 607.

Several conventional methods require repeating multiple independent runs of training of AI in order to obtain multiple policies that weigh objectives differently. In contrast, the example implementations allows the AI to learn a wide spectrum of policies in a single run of training, without manual specification for the diversity of policies.

Several conventional methods such as Stochastic Dynamic Programming require knowing the exact transition kernel P (s′|s, α) of the environment (i.e., the probability of transition to state s′ from state s by taking action α), which is unrealistic in several industrial use cases where the stochasticity of the environment is complicated. In contrast, the example implementations run without a model of the environment; it learns the stochasticity of the environment interactively through trial and error of exploration.

In conventional set-learning (or distribution-learning) methods, parametric conditions on the kind of the distribution/set are generally imposed (e.g., “The set is modeled as a mixture of three Gaussian distributions”). Compared to this, the example implementations allow learning the set (or distribution) of Q vectors in a fully non-parametric way, without using any parametric restrictive assumptions.

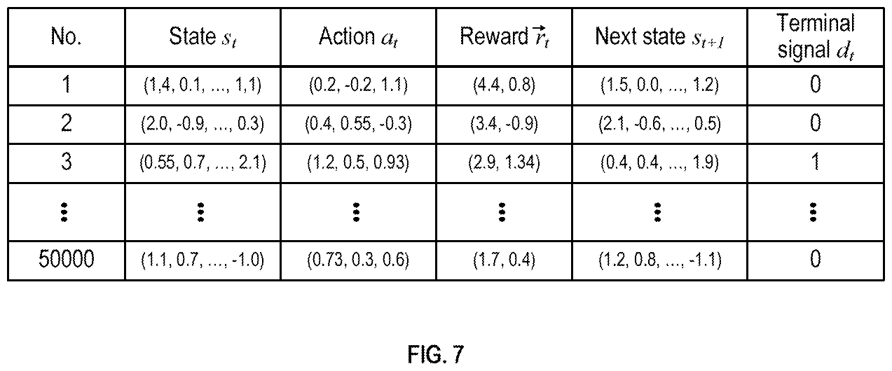

FIG. 7 illustrates an example of the sample data format in the replay buffer 108, in accordance with an example implementation. As illustrated in FIG. 7, for each iteration the state, the action, and the reward is stored, along with the next state as well as whether the termination signal has been invoked or not.

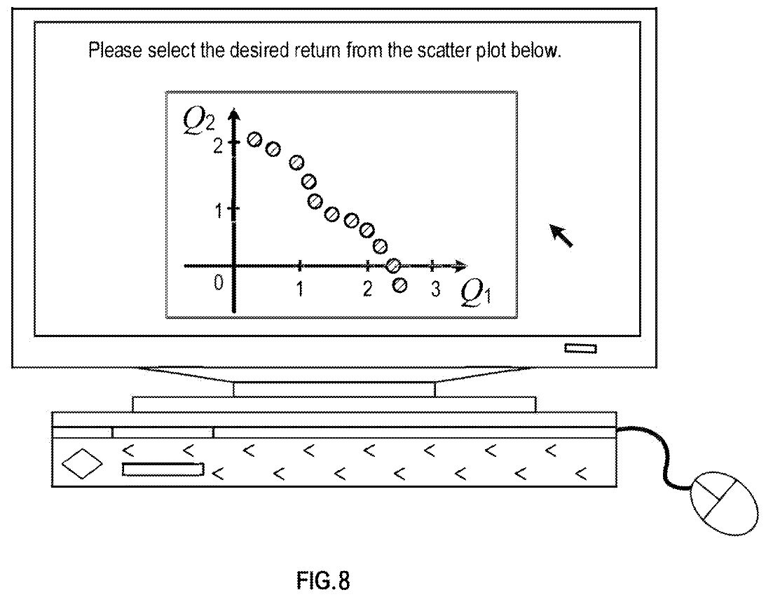

FIG. 8 illustrates an example of a sample GUI display, in accordance with an example implementation. As illustrated in FIG. 8, based on a scatter plot display, the user can change the desired return for the reinforcement learning accordingly by modifying or removing points from the curve, or otherwise in accordance with the desired implementation.

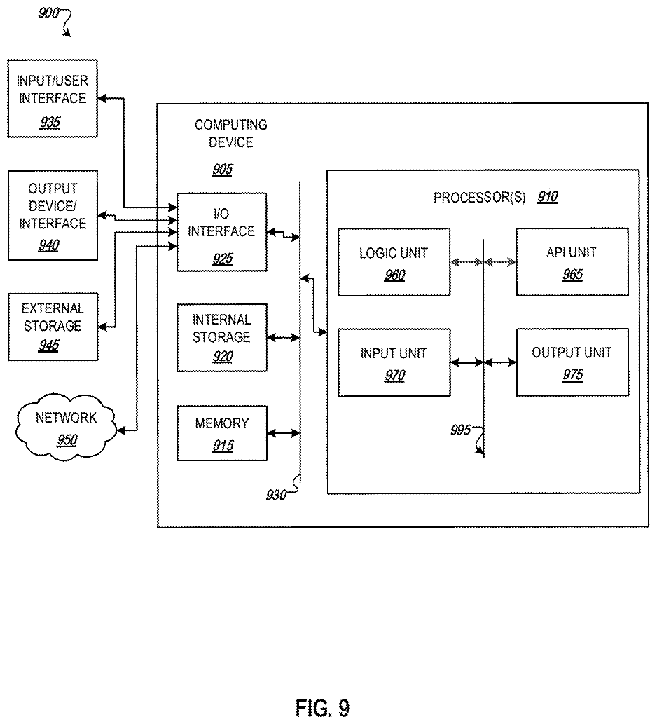

FIG. 9 illustrates an example computing environment with an example computer device suitable for use in some example implementations, such as to facilitate the functionality for multi-objective reinforcement learning system 100 as described herein. Computer device 905 in computing environment 900 can include one or more processing units, cores, or processors 910. memory 915 (e.g., RAM, ROM, and/or the like), internal storage 920 (e.g., magnetic, optical, solid state storage, and/or organic), and/or I/O interface 925, any of which can be coupled on a communication mechanism or bus 930 for communicating information or embedded in the computer device 905. I/O interface 925 is also configured to receive images from cameras or provide images to projectors or displays, depending on the desired implementation.

Computer device 905 can be communicatively coupled to input/user interface 935 and output device/interface 940. Either one or both input/user interface 935 and output device/interface 940 can be a wired or wireless interface and can be detachable. Input/user interface 935 may include any device, component, sensor, or interface, physical or virtual, that can be used to provide input (e.g., buttons, touch-screen interface, keyboard, a pointing/cursor control, microphone, camera, braille, motion sensor, optical reader, and/or the like). Output device/interface 940 may include a display, television, monitor, printer, speaker, braille, or the like. In some example implementations, input/user interface 935 and output device/interface 940 can be embedded with or physically coupled to the computer device 905. In other example implementations, other computer devices may function as or provide the functions of input/user interface 935 and output device/interface 940 for a computer device 905.

Examples of computer device 905 may include, but are not limited to, highly mobile devices (e.g., smartphones, devices in vehicles and other machines, devices carried by humans and animals, and the like), mobile devices (e.g., tablets, notebooks, laptops, personal computers, portable televisions, radios, and the like), and devices not designed for mobility (e.g., desktop computers, other computers, information kiosks, televisions with one or more processors embedded therein and/or coupled thereto, radios, and the like).

Computer device 905 can be communicatively coupled (e.g., via I/O interface 925) to external storage 945 and network 950 for communicating with any number of networked components, devices, and systems, including one or more computer devices of the same or different configurations. Computer device 905 or any connected computer device can be functioning as, providing services of, or referred to as a server, client, thin server, general machine, special-purpose machine, or another label.

I/O interface 925 can include, but is not limited to, wired and/or wireless interfaces using any communication or IO protocols or standards (e.g., Ethernet, 802.11x, Universal System Bus, WiMax, modem, a cellular network protocol, and the like) for communicating information to and/or from at least all the connected components, devices, and network in computing environment 900. Network 950 can be any network or combination of networks (e.g., the Internet, local area network, wide area network, a telephonic network, a cellular network, satellite network, and the like).

Computer device 905 can use and/or communicate using computer-usable or computer-readable media, including transitory media and non-transitory media. Transitory media include transmission media (e.g., metal cables, fiber optics), signals, carrier waves, and the like. Non-transitory media include magnetic media (e.g., disks and tapes), optical media (e.g., CD ROM, digital video disks, Blu-ray disks), solid state media (e.g., RAM, ROM, flash memory, solid-state storage), and other non-volatile storage or memory.

Computer device 905 can be used to implement techniques, methods, applications, processes, or computer-executable instructions in some example computing environments. Computer-executable instructions can be retrieved from transitory media, and stored on and retrieved from non-transitory media. The executable instructions can originate from one or more of any programming, scripting, and machine languages (e.g., C, C++, C#, Java, Visual Basic, Python, Perl, JavaScript, and others).

Processor(s) 910 can execute under any operating system (OS) (not shown), in a native or virtual environment. One or more applications can be deployed that include logic unit 960, application programming interface (API) unit 965, input unit 970. output unit 975, and inter-unit communication mechanism 995 for the different units to communicate with each other, with the OS, and with other applications (not shown). The described units and elements can be varied in design, function, configuration, or implementation and are not limited to the descriptions provided. Processor(s) 910 can be in the form of hardware processors such as central processing units (CPUs) or in a combination of hardware and software units.

In some example implementations, when information or an execution instruction is received by API unit 965, it may be communicated to one or more other units (e.g., logic unit 960, input unit 970, output unit 975). In some instances, logic unit 960 may be configured to control the information flow among the units and direct the services provided by API unit 965, input unit 970, output unit 975, in some example implementations described above. For example, the flow of one or more processes or implementations may be controlled by logic unit 960 alone or in conjunction with API unit 965. The input unit 970 may be configured to obtain input for the calculations described in the example implementations, and the output unit 975 may be configured to provide output based on the calculations described in the example implementations.

Processor(s) 910 can be configured to execute a method or instructions for obtaining Pareto optimal solutions through making sequential decisions in a system that has multi-dimensional rewards and a continuous state space, and is controllable through a finite discrete set of actions, which can involve learning a value function through reinforcement learning (RL), wherein the value function is configured to take in an input of a state and an action pair, and provides a set of vectors as output, each of the set of vectors representing an expected total sum of rewards corresponding to a sequence of future control decisions; receiving, at an initial stage of a control sequence, a request about a total sum of rewards to be achieved; and determining a sequence of actions iteratively based on the output of the value function, an observation of the current state, and the request.

Processor(s) 910 can be configured to execute the method or instructions as described above, wherein the value function is parameterized by a neural network model that samples multiple random variables from a prefixed probability distribution, merges the multiple random variables through an embedding layer with the state and the action pair input, and generates the set of vectors as output representing the expectation values of a total sum of rewards for the state and the action pair input.

Processor(s) 910 can be configured to execute the method or instructions as described above, and further involve during a training phase of the neural network, synchronizing parameters of a target neural network with parameters of the neural network with the neural network model either periodically or continuously through a Polyak update scheme.

Processor(s) 910 can be configured to execute the method or instructions as described herein, wherein learning the value function involves obtaining state transition data from the system and storing the state transition data in a reply buffer; drawing a mini-batch of random transitions from the reply buffer; determining a temporal difference (TD) error for each data in the mini-batch; determining a loss based on the TD error; and updating the value function based on a gradient of the loss.

Processor(s) 910 can be configured to execute the method or instructions as described herein, wherein the loss is computed from the TD error based on a sample-based distributional distance metric. The sample-based distributional distance metric can involve, but is not limited to, the Maximum Mean Discrepancy, the Sliced Wasserstein Distance, and so on in accordance with the desired implementation.

Processor(s) 910 can be configured to execute the method or instructions as described herein, wherein a target of the TD error for each data in the mini-batch is computed by first taking a union set of the output of the value function over all possible actions and then selecting a subset of points in the union set.

Processor(s) 910 can be configured to execute the method or instructions as described herein, wherein selecting a subset of the union set can involve ranking all points in the union set according to a distance metric from a Pareto front of an entirety of the union set: and after the ranking of the all points, selecting a portion of top-ranked ones of the all points, the selecting comprising selecting the Pareto front of the entirety of the union set.

Processor(s) 910 can be configured to execute the method or instructions as described herein, wherein the obtaining the state transition data is conducted by executing actions according to a multi-objective ε−greedy policy in which a uniformly random action is selected with some probability 0<ε≤1 and a greedy action is selected with probability 1−εwhere a greedy action is an action whose expected future total reward belongs to the Pareto front of the union set of the value function output over all actions in a given state.

Processor(s) 910 can be configured to execute the method or instructions as described herein, and further involve selecting an action in a model application phase, the selecting the action involving receiving the request for the total sum of rewards through a user interface; and after the request is received, repeating a process until a terminating condition is satisfied, the process involving observing a current state; collecting output sets of the value function for all actions; selecting the action such that the output by the value function for that action is within a threshold of the targeted total sum of rewards; executing the selected action; receiving a reward and observing a next state; and updating the targeted sum of rewards by subtracting a latest received reward from the target sum of rewards and then dividing a remainder by a temporal discount factor.

Some portions of the detailed description are presented in terms of algorithms and symbolic representations of operations within a computer. These algorithmic descriptions and symbolic representations are the means used by those skilled in the data processing arts to convey the essence of their innovations to others skilled in the art. An algorithm is a series of defined steps leading to a desired end state or result. In example implementations, the steps carried out require physical manipulations of tangible quantities for achieving a tangible result.

Unless specifically stated otherwise, as apparent from the discussion, it is appreciated that throughout the description, discussions utilizing terms such as “processing,” “computing,” “calculating,” “determining,” “displaying,” or the like, can include the actions and processes of a computer system or other information processing device that manipulates and transforms data represented as physical (electronic) quantities within the computer system's registers and memories into other data similarly represented as physical quantities within the computer system's memories or registers or other information storage, transmission or display devices.

Example implementations may also relate to an apparatus for performing the operations herein. This apparatus may be specially constructed for the required purposes, or it may include one or more general-purpose computers selectively activated or reconfigured by one or more computer programs. Such computer programs may be stored in a computer readable medium, such as a computer-readable storage medium or a computer-readable signal medium. A computer-readable storage medium may involve tangible mediums such as, but not limited to optical disks, magnetic disks. read-only memories, random access memories, solid state devices and drives, or any other types of tangible or non-transitory media suitable for storing electronic information. A computer readable signal medium may include mediums such as carrier waves. The algorithms and displays presented herein are not inherently related to any particular computer or other apparatus. Computer programs can involve pure software implementations that involve instructions that perform the operations of the desired implementation.

Various general-purpose systems may be used with programs and modules in accordance with the examples herein, or it may prove convenient to construct a more specialized apparatus to perform desired method steps. In addition, the example implementations are not described with reference to any particular programming language. It will be appreciated that a variety of programming languages may be used to implement the techniques of the example implementations as described herein. The instructions of the programming language(s) may be executed by one or more processing devices, e.g., central processing units (CPUs), processors, or controllers.

As is known in the art, the operations described above can be performed by hardware, software, or some combination of software and hardware. Various aspects of the example implementations may be implemented using circuits and logic devices (hardware), while other aspects may be implemented using instructions stored on a machine-readable medium (software), which if executed by a processor, would cause the processor to perform a method to carry out implementations of the present application. Further, some example implementations of the present application may be performed solely in hardware, whereas other example implementations may be performed solely in software. Moreover, the various functions described can be performed in a single unit, or can be spread across a number of components in any number of ways. When performed by software, the methods may be executed by a processor, such as a general-purpose computer, based on instructions stored on a computer-readable medium. If desired, the instructions can be stored on the medium in a compressed and/or encrypted format.

Moreover, other implementations of the present application will be apparent to those skilled in the art from consideration of the specification and practice of the techniques of the present application. Various aspects and/or components of the described example implementations may be used singly or in any combination. It is intended that the specification and example implementations be considered as examples only, with the true scope and spirit of the present application being indicated by the following claims.

What is claimed is:

1. A method for obtaining Pareto optimal solutions through making sequential decisions in a system that has multi-dimensional rewards and a continuous state space, and is controllable through a finite discrete set of actions, the method comprising:
learning a value function through reinforcement learning (RL), wherein the value function is configured to take in an input of a state and an action pair, and provides a set of vectors as output, each of the set of vectors representing an expected total sum of rewards corresponding to a sequence of future control decisions;
receiving, at an initial stage of a control sequence, a request about a total sum of rewards to be achieved; and
determining a sequence of actions iteratively based on the output of the value function, an observation of the current state, and the request.

2. The method of claim 1, wherein the value function is parameterized by a neural network model that samples multiple random variables from a prefixed probability distribution, merges the multiple random variables through an embedding layer with the state and the action pair input, and generates the set of vectors as output representing the expectation values of a total sum of rewards for the state and the action pair input.

3. The method of claim 2, further comprising, during a training phase of the neural network, synchronizing parameters of a target neural network with parameters of the neural network with the neural network model either periodically or continuously through a Polyak update scheme.

4. The method of claim 1, wherein learning the value function comprises:
obtaining state transition data from the system and storing the state transition data in a reply buffer;
drawing a mini-batch of random transitions from the reply buffer;
determining a temporal difference (TD) error for each data in the mini-batch;
determining a loss based on the TD error; and
updating the value function based on a gradient of the loss.

5. The method of claim 4, wherein the loss is computed from the TD error based on a sample-based distributional distance metric.

6. The method of claim 4, wherein a target of the TD error for each data in the mini-batch is computed by first taking a union set of the output of the value function over all possible actions and then selecting a subset of points in the union set.

7. The method of claim 6, wherein selecting a subset of the union set comprises:
ranking all points in the union set according to a distance metric from a Pareto front of an entirety of the union set: and
after the ranking of the all points, selecting a portion of top-ranked ones of the all points, the selecting comprising selecting the Pareto front of the entirety of the union set.

8. The method of claim 4, wherein the obtaining the state transition data is conducted by executing actions according to a multi-objective ε−greedy policy in which a uniformly random action is selected with some probability 0<ε≤1 and a greedy action is selected with probability 1−εwhere a greedy action is an action whose expected future total reward belongs to the Pareto front of the union set of the value function output over all actions in a given state.

9. The method of claim 1, further comprising selecting an action in a model application phase, the selecting the action comprising
receiving the request for the total sum of rewards through a user interface; and
after the request is received, repeating a process until a terminating condition is satisfied, the process comprising:
observing a current state;
collecting output sets of the value function for all actions;
selecting the action such that the output by the value function for that action is within a threshold of the targeted total sum of rewards;
executing the selected action;
receiving a reward and observing a next state; and
updating the targeted sum of rewards by subtracting a latest received reward from the target sum of rewards and then dividing a remainder by a temporal discount factor.

10. A non-transitory computer readable medium, storing instructions for obtaining Pareto optimal solutions through making sequential decisions in a system that has multi-dimensional rewards and a continuous state space, and is controllable through a finite discrete set of actions, the instructions comprising:
learning a value function through reinforcement learning (RL), wherein the value function is configured to take in an input of a state and an action pair, and provides a set of vectors as output, each of the set of vectors representing an expected total sum of rewards corresponding to a sequence of future control decisions;
receiving, at an initial stage of a control sequence, a request about a total sum of rewards to be achieved; and
determining a sequence of actions iteratively based on the output of the value function, an observation of the current state, and the request.

11. The non-transitory computer readable medium of claim 10, wherein the value function is parameterized by a neural network model that samples multiple random variables from a prefixed probability distribution, merges the multiple random variables through an embedding layer with the state and the action pair input, and the set of vectors as output representing the expectation values of a total sum of rewards for the state and the action pair input.

12. The non-transitory computer readable medium of claim 11, the instructions further comprising, during a training phase of the neural network, synchronizing parameters of a target neural network with parameters of the neural network with the neural network model either periodically or continuously through a Polyak update scheme.

13. The non-transitory computer readable medium of claim 10, wherein learning the value function comprises:
obtaining state transition data from the system and storing the state transition data in a reply buffer;
drawing a mini-batch of random transitions from the reply buffer;
determining a temporal difference (TD) error for each data in the mini-batch;
determining a loss based on the TD error; and
updating the value function based on a gradient of the loss.

14. The non-transitory computer readable medium of claim 13, wherein the loss is computed from the TD error based on a sample-based distributional distance metric.

15. The non-transitory computer readable medium of claim 13, wherein a target of the TD error for each data in the mini-batch is computed by first taking a union set of the output of the value function over all possible actions and then selecting a subset of points in the union set.

16. The non-transitory computer readable medium of claim 15, wherein selecting a subset of the union set comprises:
ranking all points in the union set according to a distance metric from a Pareto front of an entirety of the union set; and
after the ranking of the all points, selecting a portion of top-ranked ones of the all points, the selecting comprising selecting the Pareto front of the entirety of the union set.

17. The non-transitory computer readable medium of claim 13, wherein the obtaining the state transition data is conducted by executing actions according to a multi-objective ε−greedy policy in which a uniformly random action is selected with some probability 0<ε≤1 and a greedy action is selected with probability 1−εwhere a greedy action is an action whose expected future total reward belongs to the Pareto front of the union set of the value function output over all actions in a given state.

18. The non-transitory computer readable medium of claim 10, the instructions further comprising selecting an action in a model application phase, the selecting the action comprising
receiving the request for the total sum of rewards through a user interface; and
after the request is received, repeating a process until a terminating condition is satisfied, the process comprising:
observing a current state;
collecting output sets of the value function for all actions;
selecting the action such that the output by the value function for that action is within a threshold of the targeted total sum of rewards;
executing the selected action;
receiving a reward and observing a next state; and
updating the targeted sum of rewards by subtracting a latest received reward from the target sum of rewards and then dividing a remainder by a temporal discount factor.
